(19) United States
(12) Patent Application Publication
(10) Pub. No.: US 2021/0241928 A1
(43) Pub. Date: Aug. 5, 2021

(54) Apparatus and method for managing IoT devices

(71) Applicant: GREEN ZONE SECURITY., LTD., Hyeonpung-myeon (KR)

(72) Inventor: Shin Kim, Gimpo-si (KR)

(21) Appl. No.: 16/965,264

(22) PCT Filed: Dec. 30, 2019
(86) PCT No.: PCT/KR2019/018676

§ 371 Date: Jul. 27, 2020

(30) Foreign Application Priority Data
Apr. 26, 2019 (KR) 10-2019-0049181

(51) Int. Cl. G16Y 40/20; H04L 29/08; G16Y 20/00

(52) U.S. Cl. CPC G16Y 40/20; G16Y 20/00; H04L 67/12

(57) ABSTRACT

An apparatus for managing a device according to the present invention includes a communication unit for communication with a device and a manager apparatus and a controller transmitting a notification setting message, comprising a check timing calculation condition and a pre-notification message transmission condition based on the check timing calculation condition for the device, to the device through the communication unit, transmitting, to the manager apparatus, a pre-notification message providing notification that check timing is imminent through the communication unit when a pre-notification message is received from the device based on the pre-notification message transmission condition through the communication unit, and transmitting, to the manager apparatus, an expiration notification message providing notification that the check timing has expired through the communication unit when the expiration notification message is received from the device based on the check timing calculation condition through the communication unit.

### TECHNICAL FIELD

The present invention relates to a technology for managing Internet of Things (IoT) devices and, more particularly, to an apparatus and method for managing IoT devices through the monitoring of a plurality of IoT devices.

### BACKGROUND ART

An Internet of Things (abbreviated as an IoT) is a technology for embedding sensors and communication functions in various things and connecting the things to the Internet. That is, the IoT means a technology for connecting various things through wireless communication. The IoT is an artificial intelligence technology in which things connected through the Internet autonomously perform analysis by exchanging data and provide learnt information to a user or a user can remotely control the things. In this case, things include various embedded systems, such as home appliances, mobile equipment, and wearable devices. According to Gartner, an information technology research and consultancy, it is expected that the number of things using the IoT technology will reach 26 billion until 2020. If many things are connected as described above, massive data are collected through the Internet. The collected data are massive to the extent that it is difficult to analyze the data using the existing technology. This is called big data. A need for a technology to develop an efficient algorithm for analyzing big data comes to the fore along with the appearance of the IoT.

### DISCLOSURE

### Technical Problem

An object of the present invention is to provide an apparatus and method for managing IoT devices through monitoring in order to timing at which a plurality of IoT devices is maintained, repaired or substituted.

### Technical Solution

To achieve the above object, an apparatus for managing a device according to an embodiment of the present invention includes a communication unit for communication with a device and a manager apparatus and a controller transmitting a notification setting message, comprising a check timing calculation condition and a pre-notification message transmission condition based on the check timing calculation condition for the device, to the device through the communication unit, transmitting, to the manager apparatus, a pre-notification message providing notification that check timing is imminent through the communication unit when a pre-notification message is received from the device based on the pre-notification message transmission condition through the communication unit, and transmitting, to the manager apparatus, an expiration notification message providing notification that the check timing has expired through the communication unit when the expiration notification message is received from the device based on the check timing calculation condition through the communication unit.

After a check request message including a self-check timing calculation condition is transmitted to the device through the communication unit, when the controller receives a check result message including results of a check for a self-check performed by the device at check timing derived based on the self-check timing calculation condition, the controller transmit, to the manager apparatus, a check result message including the results of the check through the communication unit.

To achieve the above object, an apparatus for managing a device according to an embodiment of the present invention includes a communication unit for communication with a plurality of devices, and a controller embedding states of the plurality of devices in a vector space using sensor data of the plurality of devices and information on the plurality of devices when the sensor data are received from the plurality of devices through the communication unit, deriving a target check device that needs to be checked among the plurality of devices based on similarity between the states of the plurality of devices in the vector space, and transmitting a check request message to the derived target check device through the communication unit so that the derived target check device performs a self-check.

The controller embeds the states of the plurality of devices by generating vectors indicative of the states of the plurality of devices using at least one of an installation place, use of period and number of uses of the plurality of devices in addition to the sensor data of the plurality of devices and mapping the vectors to the vector space.

The controller classifies the plurality of vectors as at least one cluster through a clustering algorithm, derives a center vector at a center of gravity of the cluster, calculates the similarity based on a distance from the center vector in the vector space, and derives a corresponding device as the target check device when the similarity has a difference of a given number or more.

To achieve the above object, a method of managing a device according to an embodiment of the present invention includes deriving a condition for check timing for the device, transmitting, to the device, a notification setting message to request the device to provide information on the check timing based on the condition, transmitting, to a manager apparatus, an expiration warning message providing notification of estimated check timing when the expiration warning message including the check timing estimated by the device based on the condition is received from the device, and transmitting, to the manager apparatus, an expiration alarm message providing notification of check timing satisfying the condition by the device when the expiration alarm message including the check timing is received from the device.

To achieve the above object, a method of managing a device according to an embodiment of the present invention includes receiving sensor data from a plurality of devices, embedding states of the plurality of devices in a vector space using the sensor data of the plurality of devices and parameters for the plurality of devices, deriving a target check device that needs to be checked, among the plurality of devices, based on similarity in the vector space, and transmitting, to the derived target check device, a check request message that enables the derived target check device to perform a self-check.

### Advantageous Effects

According to the present invention, a plurality of IoT devices can be efficiently managed because timing at which a plurality of IoT devices is maintained, repaired or substituted can be previously checked through monitoring.

### DESCRIPTION OF DRAWINGS

FIG. 1 is a diagram for describing a configuration of a system for managing IoT devices according to an embodiment of the present invention.

FIG. 2 is a block diagram for describing a configuration of a management server according to an embodiment of the present invention.

FIG. 3 is a block diagram for describing a configuration of a device according to an embodiment of the present invention.

FIG. 4 is a flowchart for describing a method of managing an IoT device according to a first embodiment of the present invention.

FIG. 5 is a flowchart for describing a method of managing an IoT device according to a second embodiment of the present invention.

FIG. 6 is a flowchart for describing a method of managing an IoT device according to a third embodiment of the present invention.

FIG. 7 is a flowchart for describing a method of selecting a target check device according to an embodiment of the present invention.

FIGS. 8 and 9 are diagrams for describing method of selecting a target check device according to an embodiment of the present invention.

### MODE FOR INVENTION

Prior to the detailed description of the present invention, terms or words used in the specification and claims described hereunder should not be construed as having common or dictionary meanings, but should be construed as having meanings and concepts that comply with the technical spirit of the present invention based on the principle that the inventor may appropriately define the concepts of the terms in order to describe his or her invention in the best manner. Accordingly, embodiments described in the specification and elements shown in the drawings are merely the most preferred embodiments of the present invention and do not fully represent the technical spirit of the present invention. Accordingly, it should be understood that a variety of equivalents and modifications capable of substituting the embodiments and elements at the time of filing of this application may be present.

Preferred embodiments of this invention are described in detail below with reference to the accompanying drawings. It is to be noted that the same reference numbers are used throughout the drawings to refer to the same elements. Furthermore, a detailed description of known functions or elements that may make the gist of this invention vague will be omitted. For the same reason, in the accompanying drawings, some elements are enlarged, omitted, or depicted schematically. Furthermore, the size of each element does not accurately reflect its real size.

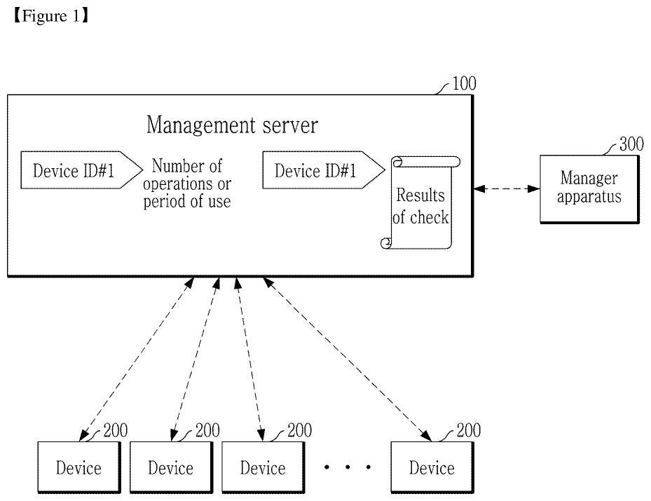

First, a system for managing an IoT device according to an embodiment of the present invention is described below. FIG. 1 is a diagram for describing a configuration of a system for managing IoT devices according to an embodiment of the present invention. Referring to FIG. 1, the system for managing an IoT device (hereinafter abbreviated as a “management system”) according to an embodiment of the present invention includes a management server 100 and a plurality of Internet of Thing (IoT) devices 200 (hereinafter abbreviated as “devices”) and a manager apparatus 300.

The management server 100 is a server for managing the plurality of devices 200. The management server 100 may enable the device 200 to actively check maintenance and check, the number of uses, and a persisting period according to a use time or period and to perform functions, such as a self-check, an operation stop, a related result report, check notification based on setting so that a manager takes proper measures.

The device 200 basically performs a sensing operation actively or passively and transmits sensing data to the management server 100. Furthermore, the device 200 may provide notification of check timing or transmit check results to the management server 100 through a self-check in response to a request from the management server 100.

The manager apparatus 300 is for managing the management server 100 while operating in conjunction with the management server 100, and is an apparatus used by the manager of the management server 100. The manager apparatus 300 may be any apparatus that performs a computing operation and performs communication over a network. For example, the manager apparatus 300 may be applied to various terminals, such as an information communication device, a multimedia terminal, a wired terminal, a stationary type terminal, and an Internet protocol (IP) terminal. For example, the manager apparatus 300 may include a mobile phone, a portable multimedia player (PMP), a mobile Internet device (MID), a smartphone, a tablet, a phablet, and a notebook, for example. The manager apparatus 300 may receive a message from the management server 100, and may output corresponding information so that the manager recognizes check timing, check expiration or check results.

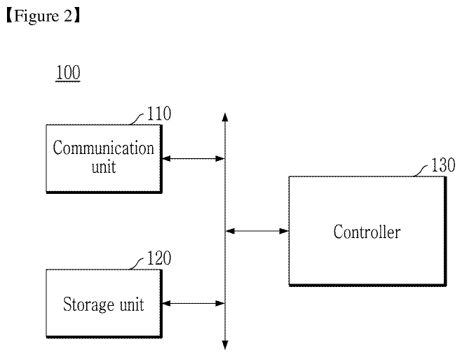

The management server 100 is described more specifically below. FIG. 2 is a block diagram for describing a configuration of the management server according to an embodiment of the present invention. Referring to FIG. 2, the management server 100 includes a communication unit 110, a storage unit 120 and a controller 130.

The communication unit 110 is means for communication with the device 200 or the manager apparatus 300. The communication unit 110 may include a radio frequency (RF) transmitter (Tx) for up-converting and amplifying the frequency of a transmitted signal and an RF receiver (Rx) for low-noise amplifying a received signal and down-converting the frequency of the received signal. Furthermore, the communication unit 110 includes a modem for modulating a transmitted signal and demodulating a received signal. The communication unit 110 may transmit, to the controller 130, data received from the device 200, and may receive data from the controller 130 and transmit the received data to the device 200.

The storage unit 120 functions to store a program and data required for an operation of the management server 100. In particular, the storage unit 120 may store a check timing calculation condition, a pre-notification message transmission condition, a self-check timing calculation condition, an installation location, installation timing, and a device type for each of the plurality of devices 200. Furthermore, the storage unit 120 may store sensor data received from each of the plurality of devices 200.

The controller 130 may control an overall operation of the management server 100 and a flow of signals between blocks within the management server 100, and may perform a data processing function for processing data. Furthermore, the controller 130 basically functions to control various functions of the management server 100. The controller 130 may be a central processing unit (CPU), a digital signal processor (DSP), etc. An operation of the controller 130 will be further described later.

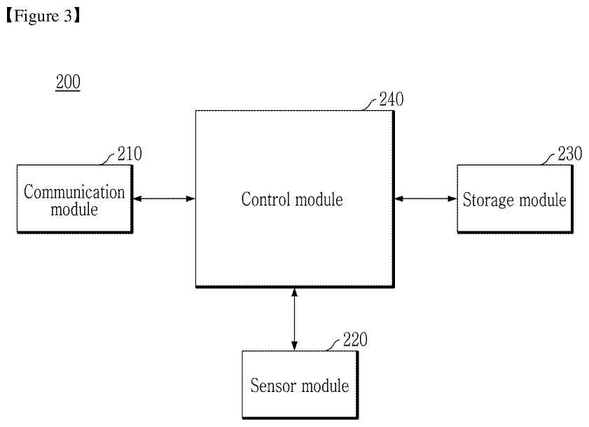

The device 200 according to an embodiment of the present invention is described below. FIG. 3 is a block diagram for describing a configuration of the device according to an embodiment of the present invention. Referring to FIG. 3, the device 200 includes a communication module 210, a sensor module 220, a storage module 230 and a control module 240.

The communication module 210 is means for communication with the management server 100. The communication module 210 may include a radio frequency (RF) transmitter (Tx) for up-converting and amplifying the frequency of a transmitted signal and an RF receiver (Rx) for low-noise amplifying a received signal and down-converting the frequency of the received signal. Furthermore, the communication module 210 includes a modem for modulating a transmitted signal and demodulating a received signal. The communication module 210 may receive data from the control module 240 and transmit the data to the management server 100. Furthermore, the communication module 210 receives data from the management server 100 and transmits the data to the control module 240.

The sensor module 220 is configured with at least one sensor. Various types may be applied to the sensor depending on the use of the device 200. Representatively, a temperature sensor, a humidity sensor, a pressure sensor, etc. may be applied to the device 200 used in a sensor network for measuring weather. Such a sensor may be classified as a passive or active sensor depending on whether power is present. The active sensor is a sensor to which power must be supplied for a sensing operation. The passive sensor does not require power supply for a sensing operation, and obtains power necessary for a sensing operation from a measurement target (or input).

The storage module 230 is for storing data of the device 200. The storage module 230 may store a check timing calculation condition, a pre-notification message transmission condition, a self-check timing calculation condition, etc.

The control module 240 may control an overall operation of the device 200 and a flow of signals between blocks within the device 200, and may perform a data processing function for processing data. Furthermore, the control module 240 basically functions to control various functions of the management server 100. The control module 240 may be a central processing unit (CPU), a digital signal processor (DSP), etc. An operation of the control module 240 will be further described later.

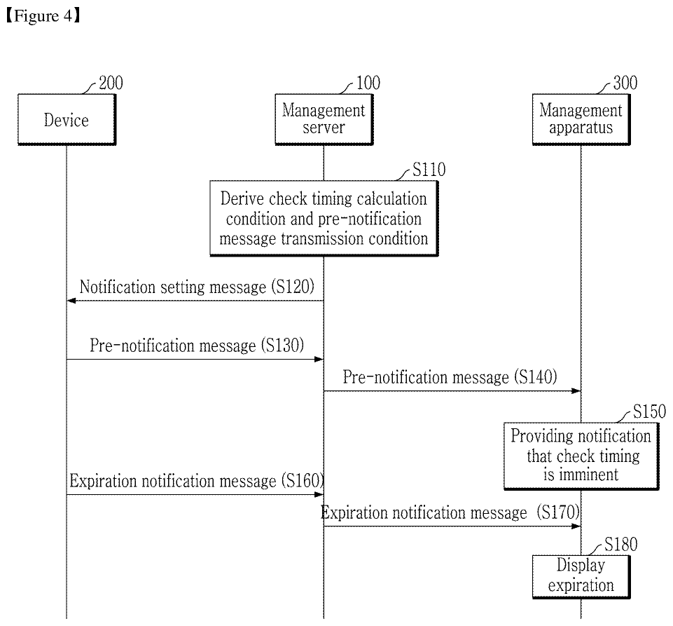

A method of managing an IoT device according to a first embodiment of the present invention is described below. FIG. 4 is a flowchart for describing a method of managing an IoT device according to a first embodiment of the present invention.

Referring to FIG. 4, at step S110, the controller 130 of the management server 100 derives a check timing calculation condition and pre-notification message transmission condition based on the check timing calculation condition of the device 200. In this case, the check timing calculation condition may be any one of the number of operations or the period of use of the device 200. As described above with respect to the check timing calculation condition, the sensor module 220 of the device 200 may be classified as an active type or a passive type. Depending on the type of sensor, check timing may be set as timing at which the device 200 performs 500 sensing operations or may be set as timing after 500 hours by accumulating the activation state of the device 200 not a deactivation or sleep state. For example, if the check timing calculation condition corresponds to 500 sensing operations, the pre-notification message transmission condition may be set as timing at which 490 sensing operations are performed. For another example, if the check timing calculation condition is a lapse of 500 hours based on the activation state, the pre-notification message transmission condition may be set as timing at which 476 hours elapse based on the activation state.

Next, at step S120, the controller 130 transmits a notification setting message, including the check timing calculation condition and the pre-notification message transmission condition, to the corresponding device 200 through the communication unit 110.

The control module 240 of the device 200 that has received the notification setting message stores the check timing calculation condition and the pre-notification message transmission condition, and determines whether the pre-notification message transmission condition is satisfied. When the pre-notification message transmission condition is satisfied, at step S130, the control module 240 transmits, to the management server 100, a pre-notification message providing notification that the check timing is imminent because the pre-notification message transmission condition has been satisfied through the communication module 210.

In response thereto, at step S140, the controller 130 of the management server 100 that has received the pre-notification message transmit, to the manager apparatus 300, the pre-notification message providing notification that the check timing is imminent through the communication unit 110. Accordingly, at step S150, the manager apparatus 300 outputs a message providing notification that the check timing is imminent so that a manager can recognize that the check timing has been imminent.

Meanwhile, the control module 240 of the device 200 determines whether the check timing calculation condition is satisfied. When the check timing calculation condition is satisfied, at step S160, the control module 240 transmits, to the management server 100, an expiration notification message providing notification that the check timing has expired because the check timing calculation condition has been satisfied through the communication module 210.

In response thereto, at step S170, the controller 130 of the management server 100 that has received the expiration notification message transmits, to the manager apparatus 300, an expiration notification message providing notification that the check timing has expired through the communication unit 110. Accordingly, at step S180, the manager apparatus 300 outputs a message providing the notification of the check timing so that the manager can recognize that the check timing has expired.

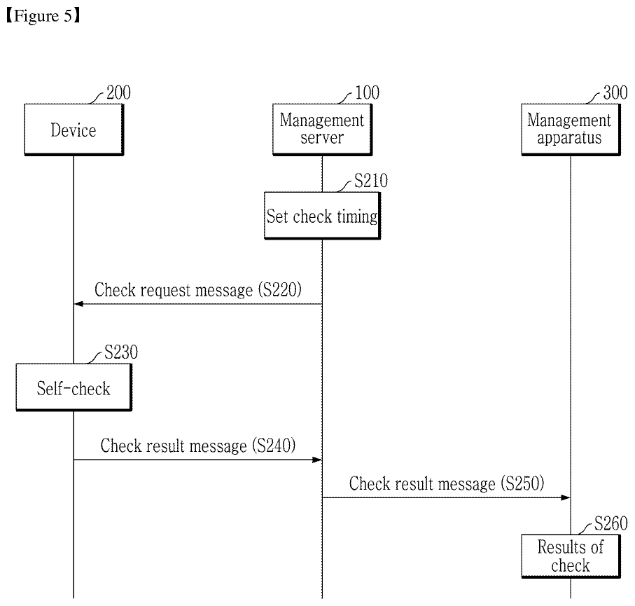

A method of managing an IoT device according to a second embodiment of the present invention is described below. FIG. 5 is a flowchart for describing a method of managing an IoT device according to a second embodiment of the present invention.

Referring to FIG. 5, at step S210, the controller 130 of the management server 100 calculates a self-check timing calculation condition based on check timing of the device 200. In this case, the self-check timing calculation condition may be any one of the number of operations or the period of use. The check timing may be set as timing at which the device 200 performs 500 sensing operations or may be set as timing at which 500 hours elapse based on the activation state not the deactivation or sleep state. Accordingly, for example, if a check timing calculation condition includes 500 sensing operations, the self-check timing calculation condition may be set as timing at which 100 sensing operations are performed. For another example, if the check timing calculation condition includes a lapse of 500 hours accumulated in the activation state, the self-check timing calculation condition may be set as timing at which 100 hours elapse after the hours are accumulated in the activation state.

Next, at step S220, the controller 130 transmits, to the corresponding device 200, a check request message including the self-check timing calculation condition through the communication unit 110.

The control module 240 of the device 200 that has received the check request message stores the self-check timing calculation condition, and determines whether the self-check timing calculation condition is satisfied. When the self-check timing calculation condition is satisfied, at step S230, the control module 240 performs a self-check for checking whether the device 200 is abnormal based on a plurality of preset check items. For example, the check items may include various types of items in addition to whether an operation of the sensor module 220 is abnormal.

Thereafter, at step S240, the control module 240 transmits, to the management server 100, a check result message including the results of the self-check through the communication module 210.

In response thereto, at step S250, the controller 130 of the management server 100 that has received the check result message transmits, to the manager apparatus 300, the check result message including the results of the self-check through the communication unit 110. Accordingly, at step S260, the manager apparatus 300 outputs the results of the check so that a manager can check the results of the check.

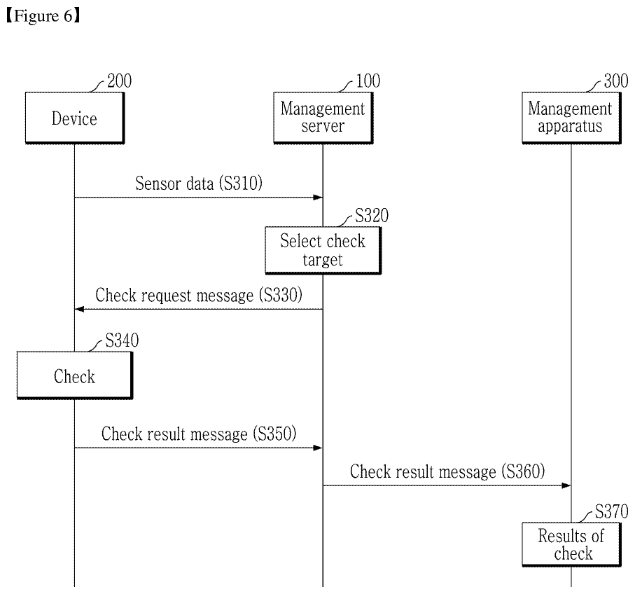

A method of managing an IoT device according to a third embodiment of the present invention is described below. FIG. 6 is a flowchart for describing a method of managing an IoT device according to a third embodiment of the present invention.

Referring to FIG. 6, at step S310, the control module 240 of each of the plurality of devices 200 may collect sensor data by performing a sensing operation through the sensor module 220, and may transmit the collected sensor data to the management server 100 through the communication module 210. Accordingly, when receiving the sensor data from each of the plurality of devices 200 through the communication unit 110, at step S320, the controller 130 of the management server 100 selects a target check device 200 among the plurality of devices 200 based on the sensor data of the plurality of devices 200 and information on the plurality of devices 200. According to an embodiment, the controller 130 may embed the states of the plurality of devices 200 in a vector space using the sensor data of the plurality of devices 200 and the information on the plurality of devices 200, and may derive a target check device 200 that needs to be checked, among the plurality of devices 200, based on similarity between the states of the plurality of devices 200 in the vector space. Step S320 will be described later more specifically.

After selecting the target check device 200, the controller 130 transmits a check request message to only the target check device 200 through the communication unit 110 at step S330.

The control module 240 of the device 200 that has received the check request message performs a self-check for checking whether the device 200 is abnormal based on a plurality of set check items at step S340. For example, the check items may include various types of items in addition to whether an operation of the sensor module 220 is abnormal.

Thereafter, at step S350, the control module 240 transmits, to the management server 100, a check result message including the results of the self-check through the communication module 210.

In response thereto, at step S360, the controller 130 of the management server 100 that has received the check result message transmits, to the manager apparatus 300, the check result message including the results of the self-check through the communication unit 110. Accordingly, the manager apparatus 300 outputs the results of the check so that a manager can check the results of the check at step S370.

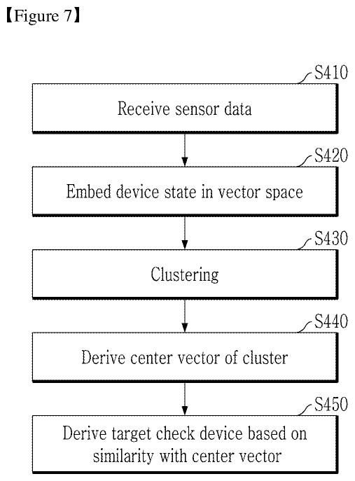

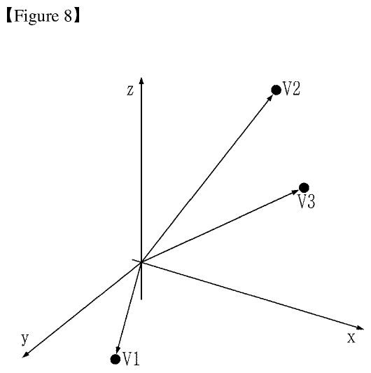

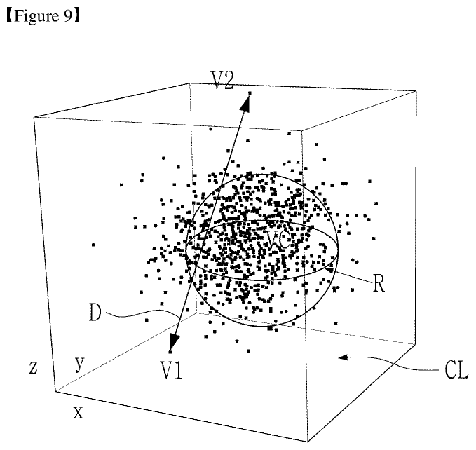

A procedure of selecting the target check device 200 according to an embodiment of the present invention is described more specifically. FIG. 7 is a flowchart for describing a method of selecting a target check device according to an embodiment of the present invention. FIGS. 8 and 9 are diagrams for describing method of selecting a target check device according to an embodiment of the present invention.

Referring to FIG. 7, at step S410, the controller 130 of the management server 100 may receive sensor data from the plurality of devices 200. Thereafter, at step S420, the controller 130 embeds the states of the plurality of devices 200 in a vector space based on the sensor data received from the plurality of devices 200 and information on the plurality of devices 200. In this case, the information on the device 200 may be an installation location, installation timing, a device type, etc.

For example, if a three-dimensional vector space is assumed, the controller 130 may represent the state of the device 200 as a vector like Equation 1 below using a sensor value of the sensor data, the installation location, and the installation timing.

V=ax+by+cz [Equation 1]

In Equation 1, x, y, and z indicate respective axes of the vector. a indicate the sensor value. b indicate the installation location. c indicates the installation timing. Values normalized in a given range are used as the sensor value, the installation location, and the installation timing.

Accordingly, as illustrated in FIG. 8, the controller 130 may embed a vector, such as Equation 1, in a three-dimensional vector space.

Next, at step S430, the controller 130 classifies, as at least one cluster, a plurality of vectors indicative of the states of the plurality of devices 200 through a clustering algorithm. Any one of a group including K-means, Mean-Shift, density-based spatial clustering of applications with noise (DBSCAN), expectation-maximization (EM) using Gaussian mixture models (GMM), and agglomerative hierarchical clustering may be representatively used as the clustering algorithm.

At step S430, the controller 130 derives a center vector located at the center of a cluster for each cluster. Thereafter, at step S440, the controller 130 derives a target check device based on similarity with the center vector. That is, the distance between vectors within the vector space indicates similarity. The controller 130 may select, as the target check device, a device 200 whose distance from the center vector corresponds to a given number or more.

One cluster is illustrated in FIG. 9. Step 5430 is described more specifically with reference to FIG. 9. In FIG. 9, illustrated dots indicate vectors, respectively. Furthermore, Vc indicates a center vector.

According to an embodiment, the controller 130 calculates two vectors whose distance therebetween is the longest within a cluster. For example, it is assumed that V1 and V2 are two vectors whose distance therebetween is the longest. Furthermore, half the distance D between two vectors whose distance therebetween is the longest is set as a reference distance R. Furthermore, a device 200 corresponding to all vectors spaced apart from a center vector at the reference distance R or more may be selected as a target check device.

According to another embodiment, the controller 130 may set the mean of distances between the vectors as the reference distance R within the cluster. Furthermore, a device 200 corresponding to all vectors spaced apart from the center vector at the reference distance R or more may be selected as a target check device.

Meanwhile, the aforementioned methods according to the embodiments of the present invention may be implemented in the form of a program readable through various computer means, and may be written in a computer-readable recording medium. In this case, the recording medium may include program instructions, a data file, and a data structure alone or in combination. The program instructions written in the recording medium may be specially designed and constructed for the present invention, or may be known and available to those skilled in computer software. For example, the recording medium include magnetic media such as a hard disk, a floppy disk and a magnetic tape, optical media such as a CD-ROM and a DVD, magneto-optical media such as a floptical disk, and hardware devices specially configured to store and execute program instructions, such as a ROM, a RAM, and a flash memory. Examples of the program instructions may include not only a machine language wire constructed by a compiler, but a high-level language wire capable of being executed by a computer using an interpreter. Such a hardware device may be configured to act as one or more software modules in order to perform an operation of the present invention, and vice versa.

Although the present invention has been described using some preferred embodiments, these embodiments are illustrative and are not restrictive. As described above, a person having ordinary knowledge in the field to which the present invention pertains may understand that the present invention may be variously changed and modified based on doctrine of equivalents without departing from the spirit of the present invention and the range of rights described in the claims.

### INDUSTRIAL APPLICABILITY

The present invention can efficiently manage a plurality of IoT devices because timing at which the plurality of IoT devices is maintained, repaired or substituted can be checked in advance through monitoring. Accordingly, the present invention has the industrial applicability because it can be sufficiently available or on the market and practically implemented evidently.

1. An apparatus for managing a device, comprising:
a communication unit for communication with a device and a manager apparatus; and
a controller transmitting a notification setting message, comprising a check timing calculation condition and a pre-notification message transmission condition based on the check timing calculation condition for the device, to the device through the communication unit, transmitting, to the manager apparatus, a pre-notification message providing notification that check timing is imminent through the communication unit when a pre-notification message is received from the device based on the pre-notification message transmission condition through the communication unit, and transmitting, to the manager apparatus, an expiration notification message providing notification that the check timing has expired through the communication unit when the expiration notification message is received from the device based on the check timing calculation condition through the communication unit.

2. The apparatus of claim 1, wherein after a check request message comprising a self-check timing calculation condition is transmitted to the device through the communication unit, when the controller receives a check result message comprising results of a check for a self-check performed by the device at check timing derived based on the self-check timing calculation condition, the controller transmit, to the manager apparatus, a check result message comprising the results of the check through the communication unit.

3. An apparatus for managing a device, comprising:
a communication unit for communication with a plurality of devices; and
a controller embedding states of the plurality of devices in a vector space using sensor data of the plurality of devices and information on the plurality of devices when the sensor data are received from the plurality of devices through the communication unit, deriving a target check device that needs to be checked among the plurality of devices based on similarity between the states of the plurality of devices in the vector space, and transmitting a check request message to the derived target check device through the communication unit so that the derived target check device performs a self-check.

4. The apparatus of claim 3, wherein the controller embeds the states of the plurality of devices by generating vectors indicative of the states of the plurality of devices using at least one of an installation place, use of period and number of uses of the plurality of devices in addition to the sensor data of the plurality of devices and mapping the vectors to the vector space.

5. The apparatus of claim 4, wherein the controller classifies the plurality of vectors as at least one cluster through a clustering algorithm, derives a center vector at a center of gravity of the cluster, calculates the similarity based on a distance from the center vector in the vector space, and derives a corresponding device as the target check device when the similarity has a difference of a given number or more.

6. A method of managing a device, comprising steps of:
deriving a condition for check timing for the device;
transmitting, to the device, a notification setting message to request the device to provide information on the check timing based on the condition;
transmitting, to a manager apparatus, an expiration warning message providing notification of estimated check timing when the expiration warning message comprising the check timing estimated by the device based on the condition is received from the device; and
transmitting, to the manager apparatus, an expiration alarm message providing notification of check timing satisfying the condition by the device when the expiration alarm message comprising the check timing is received from the device.

7. A method of managing a device, comprising steps of:
receiving sensor data from a plurality of devices;
embedding states of the plurality of devices in a vector space using the sensor data of the plurality of devices and parameters for the plurality of devices;
deriving a target check device that needs to be checked, among the plurality of devices, based on similarity in the vector space; and
transmitting, to the derived target check device, a check request message that enables the derived target check device to perform a self-check.
